(19) United States
(12) Patent Application Publication
(10) Pub. No.: US 2021/0296968 A1
(43) Pub. Date: Sep. 23, 2021

(54) SYSTEM FOR MEASURING MOTOR TEMPERATURE

(71) Applicant: KOLLMORGEN CORPORATION, Radford, VA (US)

(72) Inventors: Jeffery Todd BREWSTER, Dublin, VA (US); Steven Gregory NICHOLS, Christiansburg, VA (US); William Edward ANDERSON, IV, Blacksburg, VA (US)

(21) Appl. No.: 16/824,370

(22) Filed: Mar. 19, 2020

(51) Int. Cl. H02K 11/25

(52) U.S. Cl. CPC H02K 11/25; H02K 2211/03

(57) ABSTRACT

A system for measuring temperature in an electric motor, including a stator with field windings in the electric motor and a circuit board proximate to the field windings. The system further includes one or more thermo-electric temperature responsive devices. The thermo-electric temperature devices are mountable onto a surface of the circuit board facing the field windings. The system further includes a thermally conductive, but non-electrically conductive material, connecting the one or more thermo-electric devices to the stator windings.

### BACKGROUND OF THE INVENTION

### 1. Field of Invention

The present invention relates to measuring the temperature in an electric motor.

More specifically, the present invention relates to a system and method for measuring the temperature of a tightly wound stator field winding in an electric motor.

### 2. Description of the Related Art

A common hindrance to motor performance is overheating. Excessive temperatures can build up in the windings of a motor, and interfere with motor function. In some cases, this can result in motor damage and even cause the motor to catch fire. Accordingly, many motors use thermal devices as a means of detecting and/or preventing excessive temperatures.

Thermal devices are generally placed inside the windings of the motor and bonded thereto by an adhesive, varnish, or encapsulation. This method is successful when the windings are loose, but has been proven difficult to execute when the windings are tightly wound, given that the thermal devices must be bonded or pressed against the windings. Accordingly, there is a need in the art for a method and system for effectively measuring motor temperature in a tightly wound stator field winding.

### BRIEF SUMMARY OF THE INVENTION

An objective of the invention is to simplify the process for attaching an insulated, thermo-electric temperature device in an electric motor for the purposes of measuring the temperature of a field winding.

In accordance with a preferred embodiment of the invention, the system of the present invention includes an electric motor having a stator and field windings thereon. The system further includes, a thermo-electric temperature device for measuring temperature mounted on the surface of a circuit board adjacent to the motor stator. The device is preferably one that is capable of measuring the temperature of the field windings in the electric motor. It may be appreciated that upon receiving a reading of excessive temperatures from the field windings, the motor electronics may alter the flow of current to the field windings, thereby preventing the motor from overheating.

The system further includes a thermally conductive material disposed onto at least one of the field windings of the stator. The thermally conductive material is preferably comprised of a material that is thermally conductive, but not electrically conductive. The circuit board is preferably arranged proximally to the thermally conductive material such that the device is in contact with the thermally conductive material. It will be appreciated that the thermally conductive material conducts the heat from the field windings to the device such that the thermal sensor reads the approximate temperature of the field windings. Furthermore, the thermally conductive material creates an intimate contact between the device and the windings. The intimate contact between the device and the windings is preferred as it ensures that the device, which is secured to the circuit board, relays accurate temperature readings of the windings without the needing to be in direct contact with the winding.

### BRIEF DESCRIPTION OF THE DRAWINGS

The features and advantages of the invention are apparent from the following description taken in conjunction with the accompanying drawings in which:

FIG. 1 illustrates a system for measuring temperature in an electric motor in accordance with the present invention;

FIG. 2 illustrates a thermo-electric temperature device mounted to a circuit board; and

FIG. 3 illustrates a graph demonstrating the thermal rise of a motor having a circuit board mounted thermo-electric temperature device and thermally conductive material, in accordance with the present invention.

### DETAILED DESCRIPTION OF THE INVENTION

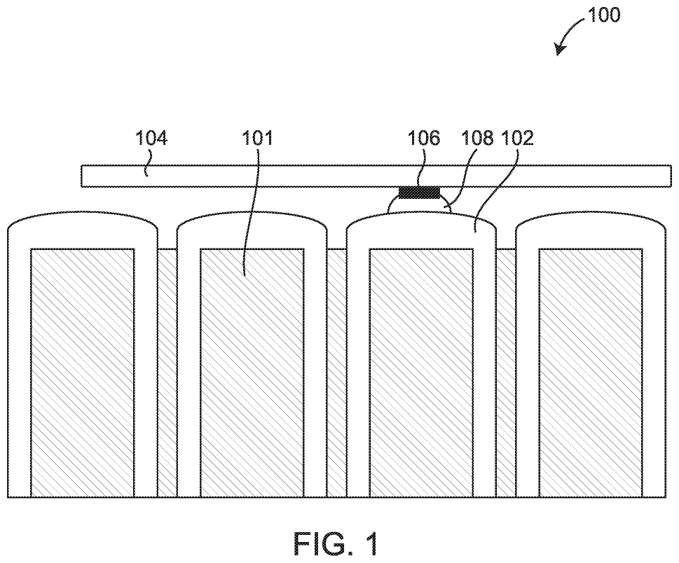

The invention relates to a system for measuring the temperature of field windings in an electric motor. FIG. 1 illustrates a preferred embodiment of the system 100 for measuring the temperature of electric motor field windings 102. The electric motor of system 100 includes a rotor (not pictured) and one or more stator teeth 101 each having a plurality of coils wrapped thereon, the coils comprising field winding 102. Specifically, FIG. 1 depicts field windings 102 wrapped tightly around stator tooth 101 of the electric motor. However, the invention is not limited to tightly wound field windings, and is equally applicable to other field winding configurations. The field windings 102 may be of any material capable of conducting electricity, preferably insulated copper wire. An electric motor of the type in which the present invention may be implemented is a permanent magnet brushless motor, such as that disclosed by U.S. Pat. No. 7,105,973 B2, issued Sep. 12, 2006, the entirety of the disclosure of which is incorporated by reference herein. It is envisioned that the invention is equally applicable to other electric motors, including those having wound rotors. The stator coils of the field windings 102 may comprise insulated copper wire wound around the stator teeth 101 of the motor. The copper wire is preferably enameled copper wire, and may be energized by flowing current through the copper wire under the control of motor electronics. The flow of the current can be controlled and adjusted by the motor electronics to produce a desired magnetic field and motor performance.

The system further includes a circuit board 104 having a thermo-electric temperature device 106 mounted thereon. The temperature device 106 may be of a material capable of conducting heat, and preferably having a resistance of 100-1000Ω at 0° C. Possible thermo-electric temperature devices for use in the invention include, but are not limited to, switching devices including bimetallic relays, avalanche PTC thermal sensors, resistive thermal devices (RTD) including KTY or PT1000. An exemplary thermo-electric temperature device of the type used in the invention is an Adafruit Platinum RTD PT1000 Sensor, Product ID: 3984, having a platinum resistance thermometer and a resistance of 1000Ω. The circuit board 104 is positioned adjacent to the field windings 102 with the surface of circuit board 104 on which the temperature device 106 is mounted facing field windings 102. Temperature device 106, mounted on the surface of the circuit board 104, is in direct contact with and surrounded by a thermally conductive material 108, positioned between the temperature device 106 and the field windings 102.

The thermally conductive material 108 is a compound suitable for conducting heat, but is preferably not electrically conductive. Examples of thermally conductive material of the kind used in the invention, include, but are not limited to adhesives, epoxies, greases, and pastes, as well as thermal pads, sheets, or foams. An example of a preferred thermally conductive material includes a thermal compound having a thermal conductivity greater than 2.5 W/(m-K), such as a Parker Therm-a-form CIP35 Thermally Conductive Cure-In-Place Compound. The thermally conductive material 108 operably connects the temperature device 106 to the field windings 102, and is configured to conduct heat from the field windings 102 and transmit such heat to the temperature device 106 with which the thermally conductive material 108 is in contact. In one embodiment, the thermally conductive material 108 may act as a binding agent, thereby binding the temperature device 106 to the field windings 102. In another embodiment, the thermally conductive material 108 may be compressed between the temperature device 106 and the field windings 102. The intimate contact of the temperature device 106 to the thermally conductive material 108 ensures that the temperature device 106 maintains proper heat conduction while the electric motor is running, ensuring consistent and accurate temperature readings of the field windings 102. Upon detecting an exceedingly high temperature reading from the temperature device 106, the motor electronics may alter or stop the flow of current to the field windings 102, thereby preventing the electric motor from overheating.

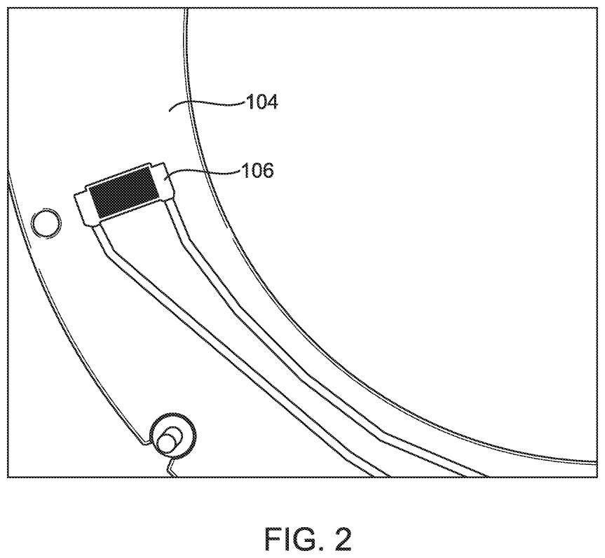

As is known in the art, the electric motor may include a circuit board 104. FIG. 2 illustrates an exemplary embodiment, wherein the circuit board 104 is a printed circuit board. The exemplary embodiment of FIG. 2 further illustrates the thermo-electric temperature device 106 being mounted onto a surface of the circuit board 104.

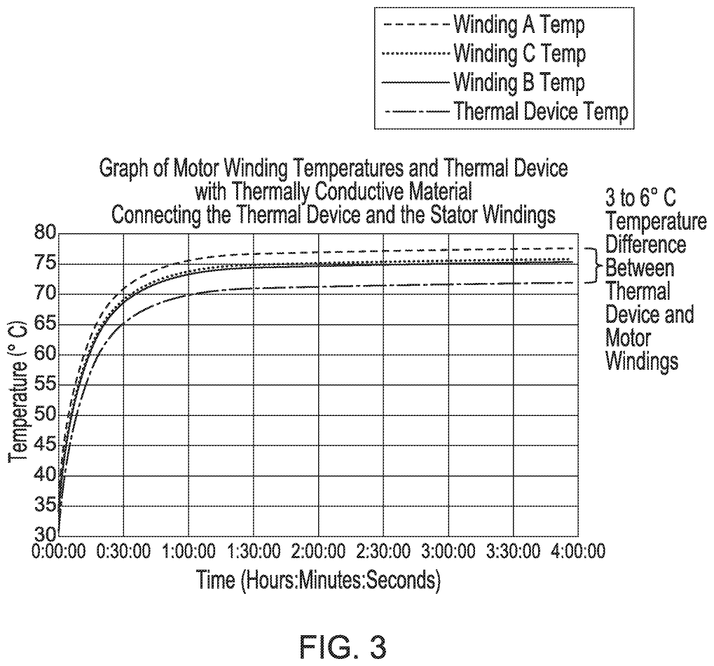

The graph in FIG. 3 illustrates the temperature of three different field windings (A, B, and C) of a permanent magnet brushless electric motor in comparison to the temperature reading of the thermo-electric temperature device 106 in accordance with the present invention. The temperature of the field windings A-C was about 75-78° C., respectively, whereas the thermo-electric temperature device had a temperature reading of about 72° C. The data suggests that the system as described herein provides a temperature reading of the field windings having a consistent fixed 3° to 6° C. temperature difference at electric motor operating temperatures in comparison to the actual temperature of the field windings 102. Accordingly, FIG. 3 demonstrates that the present invention provides an accurate and consistent reading of the temperature of the field windings of an electric motor.

Although this invention has been shown and described with respect to exemplary embodiments thereof, it should be understood by those skilled in the art that the foregoing and various other changes, omissions, and additions in the form and detail thereof may be made therein without departing form the spirit and scope of the invention. Accordingly, the present invention has been shown and described by way of illustration rather than limitation.

What is claimed:

1. A system for measuring temperature in an electric motor, comprising:
a stator with field windings in the electric motor;
a circuit board proximate to the field windings;
one or more thermo-electric temperature responsive devices mounted on a surface of the circuit board facing the field windings; and
a thermally conductive, non-electrically conductive material connecting the one or more thermo-electric devices to the stator windings.

2. The system according to claim 1, wherein the field windings of the stator are tightly wound.

3. The system according to claim 1, wherein the circuit board is a printed circuit board.

4. The system according to claim 1, wherein the thermo-electric temperature measurement device is electrically insulated.

5. The system according to claim 1, wherein the thermo-electric temperature measurement device is platinum.

6. The system according to claim 1, wherein the thermo-electric temperature measurement device has a resistance of 100-1000Ω at 0° C.

7. The system according to claim 1, wherein the thermo-electric temperature measurement device is an avalanche thermistor sensor.

8. The system according to claim 1, wherein the thermo-electric temperature measurement device is a bimetallic relays switching device.

9. The system according to claim 1, wherein the thermo-electric temperature measurement device is a linear resistive thermal device.

10. The system according to claim 1, wherein the thermally conductive material is an adhesive, epoxy, grease, or paste.

11. The system according to claim 1, wherein the thermally conductive material is a thermal pad, sheet, or foam.
